(19) United States
(12) Patent Application Publication
(10) Pub. No.: US 2009/0284452 A1
(43) Pub. Date: Nov. 19, 2009

(54) DISPLAY APPARATUS

(75) Inventors: Kenji Takata, Chiba-shi (JP); Noriyuki Shikina, Ichihara-shi (JP); Seishi Miura, Mobara-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/466,651

(22) Filed: May 15, 2009

(30) Foreign Application Priority Data
May 16, 2008 (JP) 2008-129579

(51) Int. Cl. G09G 3/30

(52) U.S. Cl. 345/77

(57) ABSTRACT

A display apparatus includes: a light-emitting device which is provided for each pixel and includes terminals; a drive portion for supplying a drive current to the light-emitting device; a voltage detection portion for detecting a voltage increase between the terminals of the light-emitting device; a correction portion for correcting the drive current for the light-emitting device; and a control portion for controlling the drive portion to supply the corrected drive current from the drive portion to the light-emitting device. The correction portion performs, for a pixel in which the detected voltage increase reaches a reference value, a correction to increase the drive current at a predetermined ratio.

### BACKGROUND OF THE INVENTION

1. Field of the Invention

The present invention relates to a display apparatus, and more particularly, to a display apparatus including a light-emitting device energized to emit light, such as an organic EL device.

2. Description of the Related Art

In recent years, attentions have been paid to self-emission type devices for flat panels. The self-emission type devices include plasma-emission display devices, field emission devices, and electroluminescence (EL) devices.

Of those, the EL devices, in particular, organic EL devices have been energetically studied and developed. An area-color type array arrangement of organic EL devices, such as one with a single color of green or further added with blue, red, or any of other colors, has been commercialized. Currently, development of a full-color type has been actively conducted.

It has been known that, when light is continuously emitted from the organic EL device for a long period of time, a change occurs in which luminance reduces and a voltage increases.

For example, when a white fixed pattern is displayed on a black background in a display in which a plurality of pixels is arranged in a matrix pattern, as illustrated in FIG. 2, a black portion does not degrade because the black portion is turned off and a white portion reduces in luminance.

When the entire region is uniformly turned on after the pattern is displayed for a long period of time, a portion in which the fixed pattern is displayed is darker than other portions. This portion is recognized as character or picture burn-in.

When the burn-in is recognized, the image quality of the display apparatus significantly degrades.

A proposed method of compensating for the change of the organic EL device includes a technology of detecting a drive voltage of the organic EL device and correcting corresponding pixel data based on the drive voltage, thereby correcting a reduction in luminance of each light-emitting device for each pixel, as described in Japanese Patent Application Laid-Open No. 2006-091709.

However, when the drive voltage is detected and the pixel data is corrected based on the change in drive voltage, luminance of a pixel is determined to have been reduced even in the case of no luminance degradation. Therefore, there is a case where the pixel data is corrected to increase light emission, and hence more intense light is adversely emitted. Which pixel becomes such a state is described later. In all cases, when the drive voltage of the light-emitting device is merely detected, there is a problem that the luminance degradation cannot be accurately compensated.

### SUMMARY OF THE INVENTION

The present invention has been accomplished in view of the above-mentioned circumstances.

Therefore, the display apparatus according to the present invention includes: a light-emitting device which is provided for one pixel and has terminals; a drive portion for supplying a drive current to the light-emitting device; a voltage detection portion for detecting a voltage increase between the terminals of the light-emitting device; a correction portion for correcting the drive current for the light-emitting device; and a control portion for controlling the drive portion to supply the corrected drive current from the drive portion to the light-emitting device, wherein the correction portion performs, for a pixel in which the detected voltage increase reaches a reference value, a correction to increase the drive current by a predetermined ratio.

According to the present invention, it is possible to obtain the display apparatus in which a change in luminance is suppressed.

Further features of the present invention become apparent from the following description of exemplary embodiments with reference to the attached drawings.

### BRIEF DESCRIPTION OF THE DRAWINGS

FIG. 1 is a conceptual diagram illustrating an embodiment of the present invention.

FIG. 2 is a conceptual graphical representation illustrating luminance degradation.

FIGS. 3A, 3B, and 3C are graphical representations illustrating examples of a time-dependent change in luminance of an organic EL device.

FIGS. 4A, 4B, and 4C are graphical representations illustrating examples of a luminance-current efficiency relationship during drive degradation in the organic EL device.

FIGS. 5A, 5B, and 5C are graphical representations illustrating a manner of determining a current correction coefficient based on a display luminance and a degradation amount.

FIG. 6 is a conceptual diagram illustrating another embodiment of the present invention.

FIG. 7 is a circuit diagram illustrating a display apparatus according to the present invention.

FIG. 8 is a conceptual graphical representation illustrating dependence of an increased reversible voltage on a duty ratio.

FIGS. 9A and 9B are graphical representations illustrating another manner of determining the current correction coefficient based on the display luminance and the degradation amount.

### DESCRIPTION OF THE EMBODIMENTS

Preferred embodiments of the present invention will now be described in detail in accordance with the accompanying drawings.

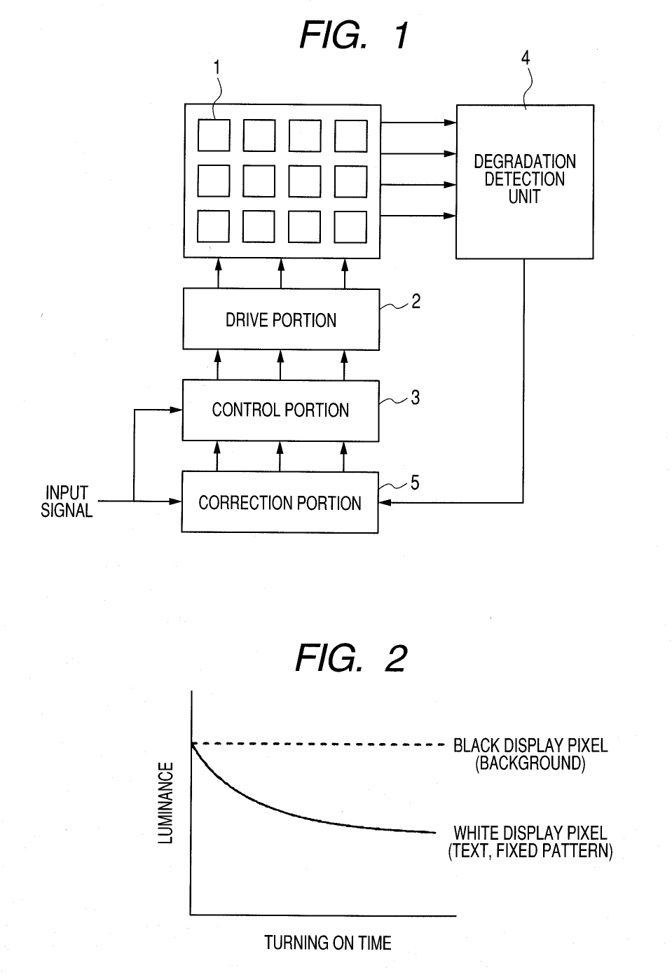

FIG. 1 is a conceptual diagram illustrating a structure of a display apparatus according to an embodiment of the present invention.

The display apparatus illustrated in FIG. 1 includes an organic electroluminescence (EL) device 1 which is a light-emitting device, a drive portion 2 for supplying a power to the organic EL device 1, a control portion 3 for controlling the drive portion 2 based on an input signal, a degradation detection unit 4 for detecting the degradation of the organic EL device 1, and a correction portion 5 for correcting an output to the organic EL device 1 according to the degradation of the organic EL device 1. A plurality of organic EL devices is disposed and each serves as a pixel in a matrix pattern.

As described later, the correction portion 5 measures a voltage between terminals of the organic EL device 1 and determines that the organic EL device 1 degrades when the voltage increasing from the start of driving reaches a reference value. When a display signal is input from an outside to the organic EL device, the correction portion 5 corrects the input signal so as to increase a drive current corresponding thereto by a predetermined ratio. The corrected signal is output as the drive current to the organic EL device through the control portion and the drive portion.

<Degradation Characteristic of Organic EL Device>

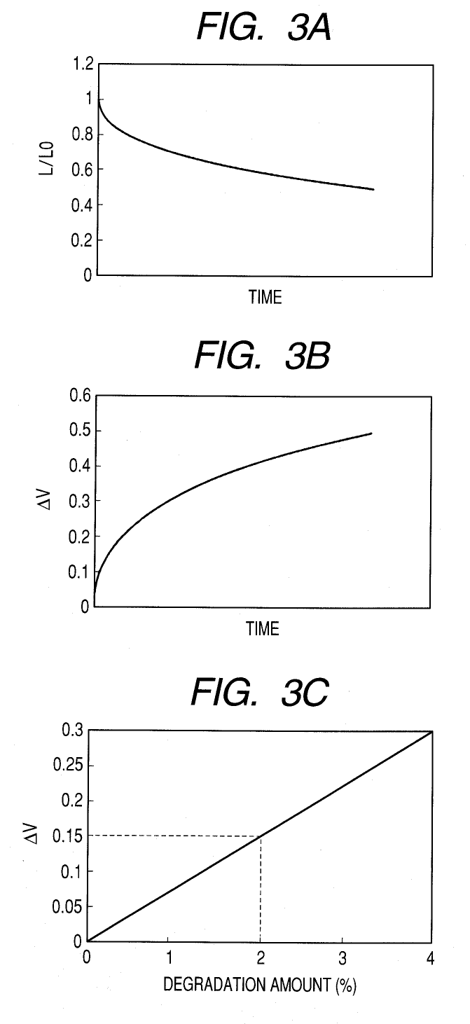

FIGS. 3A, 3B, and 3C illustrate an increase in voltage and a reduction in luminance due to the degradation of an organic EL device.

FIGS. 3A and 3B illustrate a time-dependent change in luminance of the organic EL device and a time-dependent change in voltage between the terminals thereof, respectively, in a case where the organic EL device is continuously driven with a predetermined current to emit light. The luminance is normalized based on the assumption that the luminance at the start of driving (time 0) is 1. The voltage exhibits a change in voltage between the terminals from the initiation (time 0). Therefore, the degradation of the organic EL device progresses with the reduction in luminance and the increase in voltage.

FIG. 3C illustrates a relationship between luminance degradation (abscissa) and a voltage increase (ordinate), derived from FIGS. 3A and 3B. Hereinafter, this relationship is referred to as a degradation characteristic.

In a case where the relationship illustrated in FIG. 3C is found, when the reduction amount of luminance is estimated from an increased value of the voltage between the terminals and the drive current is corrected, the luminance can be maintained to a constant value, that is, degradation compensation can be achieved. When a voltage increase of 0.15 V is detected, the drive current may be corrected so as to increase the luminance by 2% based on the assumption that the luminance is degraded to 98% of initial luminance. As described above, in the case of continuous light emission, the luminance degradation and the increased amount of voltage have a predetermined relationship with each other, and hence the luminance degradation can be accurately compensated.

However, in a display apparatus including a plurality of pixels, of a television set or a mobile phone, continuous light emission is not performed from in the pixels and the luminance of each of the pixels is frequently changed depending on displayed information. As a result, the progress of degradation is also changed depending on each of the pixels.

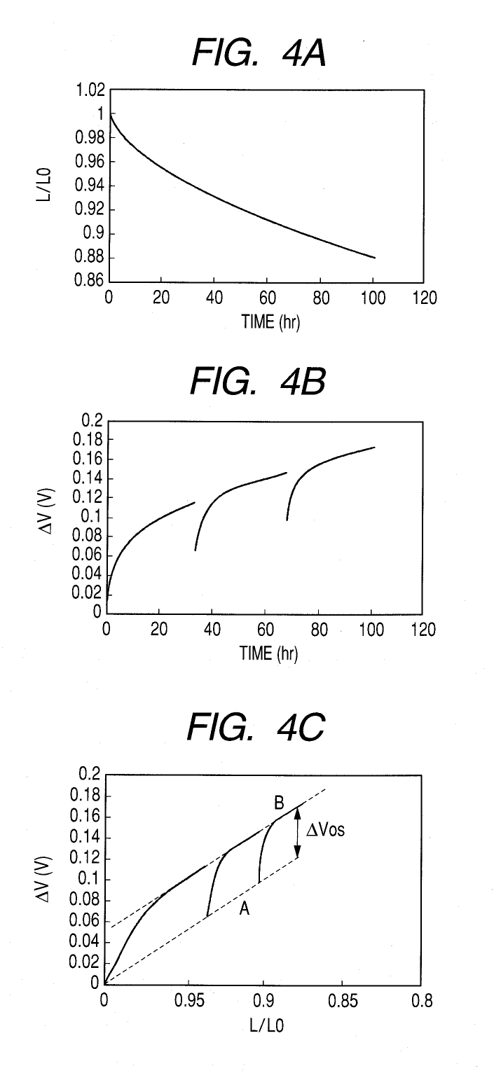

FIGS. 4A and 4B illustrate time-dependent changes in luminance degradation and voltage increase in a case where the organic EL device is repeatedly driven and suspended. The abscissa indicates the accumulation of drive time. In FIG. 4B, a first branch extending from time 0 corresponds to a change in voltage during first driving. A second branch corresponds to an increase in voltage while continuous driving is performed for 33 hours, temporarily suspended, and then restarted. A third branch corresponds to an increase in voltage while driving is suspended after 65 hours and then restarted.

As illustrated in FIG. 4A, the luminance is not changed before and after the suspension of driving. When the driving is restarted, light is emitted again with the luminance immediately before the suspension. The reduction amount of luminance is determined not depending on a suspension time but depending on an accumulated drive time.

In contrast to this, as illustrated in FIG. 4B, a voltage increased during driving slightly reduces because of the suspension of driving, whereby a part of the voltage increased during driving is restored. After restarting, when the voltage rapidly increases and thus becomes closer to the voltage before suspension, the increase becomes slower and returns to a voltage increase rate before suspension.

FIG. 4C illustrates a relationship between luminance degradation and a voltage increase, which corresponds to FIGS. 4A and 4B. Respective branches correspond to the branches illustrated in FIG. 4B. A dashed line “A” indicates a curve obtained by joining plot points of voltage and luminance immediately after the restart of driving. A dashed line “B” indicates an envelope produced based on a voltage-luminance relationship after driving is performed for a sufficiently long period of time from the restart of driving. Each of the dashed lines becomes a substantially straight line. However, this is not essential to the present invention.

A voltage ΔVos corresponding to an interval between the dashed lines “A” and “B” is a voltage restoration component caused by the suspension. A change in voltage corresponding to the voltage restoration component is reversible. The voltage restores during the suspension of driving, and thus becomes zero. Immediately after the restart of driving, the voltage rapidly returns to the value before suspension.

When a suspension time is sufficiently long, a voltage immediately after the restart through the suspension is restored to the voltage indicated by the dashed line “A”. In contrast to this, when the suspension time is short, the voltage immediately after the restart is restored to an intermediate value. Therefore, the voltage immediately after the restart depends on the length of the suspension time.

In general, the reduction in luminance of the organic EL device is considered to be attributable to an irreversible change of an inner portion of the organic EL device, that is, degradation thereof. However, as can be seen from FIGS. 4B and 4C, during a predetermined period immediately after the restart of driving, the voltage rapidly increases without substantially reducing the luminance, and the corresponding change in voltage is a reversible change which can be reversed when light emission is stopped.

The reason why the reversible voltage change as described above occurs is not sufficiently clear, but the reversible change in voltage can be assumed as a phenomenon that a parasitic capacitor between both the terminals of the organic EL device is charged and discharged. The parasitic capacitor is charged during the drive period and discharged during the suspension period. When the drive time or the suspension time is sufficiently long, a parasitic capacitor voltage saturates. When the drive time or the suspension time is short, charging and discharging do not saturate and thus an intermediate voltage appears.

<Degradation Characteristic Depending on Duty Ratio>

As described above, the detected time-dependent change in voltage between the terminals of the organic EL device is a sum of an irreversible change component and a reversible change component ΔVos.

According to experiments made by the present inventors, it has been found that, when a ratio of a time for which a current is supplied to the organic EL device with respect to one frame period (hereinafter referred to as duty ratio) is varied, the magnitude of the reversible voltage change varies. This result is illustrated in FIG. 8.

FIG. 8 illustrates a relationship between a duty ratio and a reversible voltage change ΔVr in a case where the organic EL device is continuously turned on for one hour. The reversible voltage change ΔVr at the time of driving with a duty ratio of 100% is equal to ΔVos illustrated in FIG. 4C. When the duty ratio reduces, ΔVr becomes smaller, and when extrapolated to a duty ratio of 0%, ΔVr becomes substantially 0 V.

The result illustrated in FIG. 8 shows that the width of the reversible voltage change can be controlled based on the duty ratio. When the organic EL device is driven with a duty ratio of 0%, there is no reversible change, whereby the voltage increases along the dashed line “A” of FIG. 4C. In this case, the increase in voltage and the luminance degradation are in one-to-one correspondence.

In order to obtain the characteristic illustrated in FIG. 8, continuous driving is performed with a determined duty ratio for a long period of time to measure a voltage increase. After that, the driving is suspended for a sufficiently long period of time to measure a subsequent voltage. A difference between the two voltages is the reversible voltage change ΔVr.

According to another method involving obtaining the characteristic illustrated in FIG. 8, voltage increase during long-time continuous driving are measured with different duty ratios. A difference between a value obtained by extrapolating the voltage increase to the duty ratio of 0% and each of the voltage increase is assumed as the reversible voltage change ΔVr.

<Compensation for Luminance Degradation>

The present invention utilizes the change in reversible voltage according to the duty ratio illustrated in FIG. 8 to solve the luminance degradation of the display apparatus in which the degree of degradation changes depending on pixels and the voltage increase changes depending on the suspension time and the elapsed time after suspension.

As described with reference to FIGS. 4A to 4C, when only the voltage between the terminals of the organic EL device is detected, the voltage includes the reversible voltage change component, and hence the reduction in luminance (luminance degradation) cannot be determined. In the present invention, the voltage increase of a pixel is periodically monitored. When the voltage value exceeds a predetermined reference voltage (for example, 0.1 V), the pixel is assumed to degrade and an input signal is corrected. Whether or not the correction is required is determined based on whether or not the detected voltage between the terminals exceeds the reference voltage value. Therefore, a simple comparator circuit (comparator) can be used as a detection circuit. The correction is performed for pixels based on only the present voltage without considering the suspension time and the elapsed time after suspension. Thus, the degree of degradation may be various among the pixels. Nevertheless, the differences thereamong are neglected and every pixel is corrected in the same manner. A way of correction is to increase the drive current of pixels to be corrected uniformly, by multiplying a constant ratio, for example 10%, to a predetermined current corresponding to the input signal.

A display signal is input from the outside to the display apparatus for each pixel. The drive portion supplies a drive current Isig corresponding to the input signal to the organic EL device. The correction portion corrects the input signal so as to supply, to the organic EL device, a drive current aisig obtained by multiplying the drive current Isig by a predetermined correction coefficient “a”. Alternatively, a correction signal may be sent to a data signal output source of the drive portion without correcting the input signal, to thereby generate a corrected current by the drive portion. When the degradation characteristic is known for each magnitude of the drive current, the correction coefficient “a” may be changed according to the drive current. However, there is no case where the correction coefficient “a” is changed for each degraded pixel, and the correction is performed using the predetermined correction coefficient.

In the case of the organic EL device degraded as illustrated in FIG. 4C, when the voltage increase (ordinate) is 0.1 V, the luminance reduction (abscissa) L/L0 is within a range of from approximately 0.9 to 0.95. In a pixel exhibiting luminance degradation close to a case of L/L0=0.9, the major part of the voltage increase is the irreversible change component, and hence the degradation progresses. In contrast to this, in a pixel exhibiting luminance degradation close to a case of L/L0=0.95, approximately ½ of the voltage increase is the reversible change component and the remainder thereof is the irreversible change component, and hence the progress of degradation is slower than that in the pixel with L/L0=0.9. By observing only the increase in voltage, the difference cannot be recognized.

When all the pixels are subjected to the current correction with a predetermined ratio (10% increase), the luminances are equally increased by substantially 10%. As a result, the luminance of the pixel with L/L0=0.9 returns to luminance just before degradation. However, the luminance of the pixel with L/L0=0.95 becomes a luminance of 105%. Therefore, the corresponding pixel becomes brighter, and hence accurate correction cannot be performed and the degradation is hastened because of an increase in current.

In the case described above, the luminance degradation is within the range of from 0.9 to 0.95. This is because the driving is performed with a duty ratio of 100%. When a luminance degradation difference is smaller, a variation in luminance after correction is also within a narrower range.

In order to prevent a luminance difference after correction from being visually recognized, driving with a duty ratio smaller than 1 (100%) is desirable. As illustrated in FIG. 8, when the duty ratio reduces, the width of the reversible voltage change reduces, and hence the interval between the dashed lines “A” and “B” of FIG. 4C also becomes smaller. This corresponds to that the variation in luminance degradation of the pixels having the same voltage increase of 0.1 V is small, and hence a variation in luminance after correction is suppressed to a small level. Driving with a duty ratio equal to or smaller than a certain value is expected to prevent the luminance difference after correction from being visually recognized. According to the driving with such a duty ratio as described above or smaller, the width of a distribution corresponding to the degree of the degradation of the pixels having the same voltage increase is reduced and the current is increased at the predetermined ratio to thereby correct the luminance. The distribution corresponding to the degree of the degradation is narrow, and hence a distribution of luminance after correction is small. Therefore, the luminance difference can be set to the extent that cannot be visually recognized, that is, set within an allowable range for the display apparatus. Thus, the reduction in luminance can be compensated only by detecting the increase in voltage.

The distribution corresponding to the degree of the degradation is narrowed by reducing the duty ratio. In addition to this, the reference value for the voltage increase may be set to a small value.

Hereinafter, the present invention is described in detail with reference to the drawings.

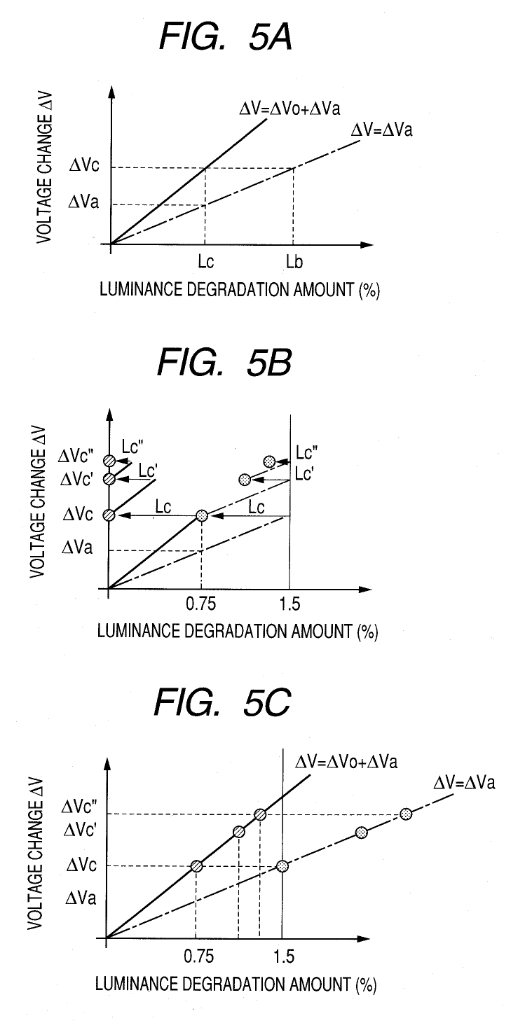

FIG. 5A illustrates a relationship between an increase in voltage and luminance degradation in a case where driving is performed with a certain duty ratio (solid line) and a relationship between an increase in voltage and luminance degradation obtained by extrapolation thereof to the duty ratio of 0% (alternate long and short dash line). The abscissa indicates luminance degradation, that is, a difference between initial luminance and luminance after degradation. The ordinate indicates a voltage increase from an initial voltage. FIG. 4C illustrates both the lines which are parallel to each other, but FIG. 5A illustrates both the lines which have different gradients. In general, the characteristics are not necessarily a straight line or parallel.

It is assumed that a voltage increase which is a reference for determining whether or not there is degradation and performing correction is expressed by ΔVc. A maximum value of luminance degradation of a pixel in which the voltage increase reaches ΔVc is expressed by Lb, and corresponds to the luminance degradation of a pixel whose display is suspended for a long period of time or a pixel which continues to display black for a long period of time. A minimum value of luminance degradation is expressed by Lc, and corresponds to the luminance degradation of a pixel which continues to display white (maximum luminance) for a long time. The luminance degradation of each of the other pixel (in which voltage increase reaches ΔVc) is between Lb and Lc.

In the case of an actual display apparatus, the two characteristics illustrated in FIG. 5A, of an organic EL device serving as a reference device are measured and stored in advance. In other words, with continuous driving being performed with a predetermined duty ratio, the increase in voltage and the luminance degradation are measured. Those results are plotted by the solid line. The same measurement is performed with smaller duty ratios. A characteristic between the increase in voltage and the luminance degradation is determined by extrapolating results obtained by measurement with some duty ratios to the duty ratio of 0%. Those results are plotted by the alternate long and short dash line.

The reference value ΔVc of the voltage increase is determined based on allowable luminance unevenness. The luminance degradation progresses between the two characteristics illustrated in FIG. 5A, and hence the luminance degradation (alternate long and short dash line) Lb of a pixel exhibiting maximum luminance degradation, of pixels having the same voltage increase, causes an uneven luminance width. When the luminance degradation is outside an allowable limit range (larger luminance difference is visually recognized), the luminance unevenness of the display apparatus is visually recognized. Therefore, the reference value is determined as a voltage increase value in a case where Lb is equal to an allowable luminance degradation limit.

When a pixel in which the voltage increase reaches the reference value is corrected, a pixel exhibiting the minimum luminance degradation (solid line of FIG. 5A) Lc is corrected to return to original luminance (luminance degradation of 0). That is, the luminance correction amount is Lc. In this case, luminance degradation after correction, of a pixel exhibiting the maximum luminance degradation Lb is Lb-Lc.

FIG. 5B illustrates a change in luminance in a case where, when the allowable luminance unevenness limit between the maximum luminance degradation (alternate long and short dash line) and the minimum luminance degradation (solid line) is assumed to be 0.75%, a pixel in which the voltage increase reaches the reference value ΔVc is detected and subjected to drive current correction. The base of each arrow indicates luminance before correction and the tip thereof indicates luminance after correction. The luminance before correction is unknown, and hence luminances cannot be separately corrected. The correction is performed so as to uniformly increase the luminances by Lc.

In the example illustrated in FIG. 5B, when the maximum luminance degradation corresponding to the voltage increase ΔVc reaches an allowable limit of 1.5%, the correction is performed with the correction amount Lc. In this case, all the pixels are corrected at the same time to increase the luminance by 0.75%.

When the luminance after correction exceeds the original luminance and thus is corrected to be bright, the luminance becomes higher than luminance of an organic EL device which is not degraded. The luminance degradation of the organic EL device becomes larger as the luminance increases. Therefore, when the luminance after correction is higher than the initial value, the luminance degradation of the organic EL device progresses. Thus, the correction is desirably performed so that the degradation amount after correction does not become smaller than 0 (that is, luminance after correction does not become larger than luminance before correction). In other words, the luminance correction amount Lc is determined so that the luminance after correction, of a pixel of which degradation is latest on the solid line (that is, pixel which has been continuously driven until then and has voltage increase reaching reference value), of pixels in which the voltage increase reaches the reference value, returns to luminance just before degradation (luminance degradation of 0).

In the case of FIG. 5B, when the luminance after correction, of the pixel of which degradation is latest on the solid line (that is, pixel which has been continuously driven until then and has voltage increase reaching reference value) is to be prevented from being corrected to be bright, correction is desirably performed so that luminance at a maximum duty ratio is equal to Lc in the light emission at the duty ratio of 0%. In this case, the correction amount Lc is 0.75%.

FIG. 5B illustrates the increase in voltage and luminance degradation also in a case where driving is further performed after the first correction. In a pixel having luminance degradation of 1.5% which is the largest, the degraded luminance is restored to a state of 0.75% by the first correction. After that, the increase in voltage and the luminance degradation progress again (second alternate long and short dash line). In a pixel having luminance degradation of 0.75% which is the smallest, the luminance degradation returns to 0% which is equal to a value before degradation because of correction. Then, the luminance degradation follows on a voltage increase line (second solid line) again.

FIG. 5C is a continuous connection representation of the respective branches of FIG. 5B to clarify the relationship between the change in voltage and the change in luminance and the correction amount of FIG. 5B.

The second correction is performed in a case where the pixel which has the luminance restored by the first correction and exhibits the maximum luminance degradation exceeds the allowable limit of 1.5% again. The correction is expressed by an intersection of the second alternate long and short dash line of FIG. 5B and a line in which the luminance degradation amount is 1.5%. The pixel exhibiting the minimum luminance degradation is returned to the original luminance (degradation amount is 0%) by the first correction. Because of the subsequent degradation (second solid line), the luminance degradation reaches a point of Lc′=0.375%. The second correction needs to be performed within a range in which the maximum luminance does not become higher than the original luminance, and hence the second correction amount is Lc′ which is a half of the first correction amount Lc.

After that, third, fourth, and subsequent corrections can be continued. As in this example, in the case where the degradation characteristic is obtained in which the interval between the degradation of the pixel exhibiting the maximum luminance degradation (alternate long and short dash line) and the degradation of the pixel exhibiting the minimum luminance degradation (solid line) is unilaterally widened, when the interval becomes equal to or wider than the allowable limit range (1.5%) of the luminance, both the pixels cannot be maintained within the allowable limit range by correction. This state is an applicable limit of the correction system. The duty ratio is desirably determined such that a period of time to reach the limit becomes equal in length to an equipment useful life.

When the duty ratio is close to 1, the interval between the alternate long and short dash line and the solid line of FIG. 5A is wide, and hence the period to reach the limit of correction is short.

When the degradation characteristic difference is maintained within the predetermined interval without unilaterally widening as illustrated in FIG. 4C, both the pixel exhibiting the maximum luminance degradation (degradation characteristic “A” indicated by alternate long and short dash line of FIG. 5A) and the pixel exhibiting the minimum luminance degradation (degradation characteristic “B” indicated by solid line of FIG. 5A) can be constantly maintained within the allowable limit as long as there is no limit on the increase in voltage. In the example of FIG. 4C, the interval between the degradation characteristics “A” and “B” is approximately 5% in luminance. When the allowable limit is 1.5%, the interval exceeds the allowable limit. The degradation characteristic “B” of FIG. 4C is a characteristic with a duty ratio of 100%. Therefore, when the duty ratio is set to a small value, the interval can be reduced to 1.5%. The reversible voltage change ΔVr of FIG. 8 corresponds to ΔVos of FIG. 4C. As is seen from FIG. 8, when the duty ratio is 20%, ΔVr reduces to approximately 30% of the value at the duty ratio of 100%. Thus, when the duty ratio is set to a value equal to or smaller than 20%, the degradation correction can be achieved with the allowable limit of 1.5%.

According to the correction system illustrated in FIGS. 5B and 5C, the example in which the correction is performed such that the luminance after correction does not become higher than the luminance before degradation, that is, the initial luminance is described. However, the luminance after correction may be within a predetermined narrow range from the luminance before degradation. Hereinafter, such a case is described.

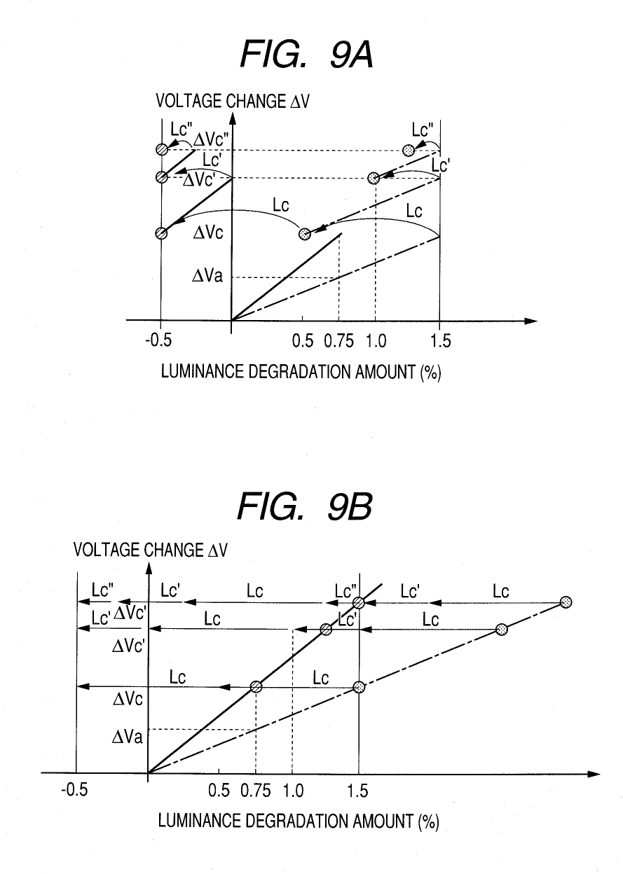

FIG. 9A illustrates a relationship among a voltage increase amount, a luminance degradation amount, and a correction amount at Lb=1.5% (luminance degradation limit), Ld=0.5% (luminance increase limit), and Lc=1% (luminance correction amount). A state is illustrated in which correction is performed such that luminance after correction is not lower than Ld.

FIG. 9B is a continuous representation of the state of FIG. 9A as in the case of FIG. 5C.

A case where the luminance after correction is higher by Ld than the luminance of an organic EL device before degradation or the luminance of an organic EL device which is not degraded is also assumed as an allowable case. In this case, when the following relationship

ΔVa/(ΔVo+ΔVa)≧Lc/(ΔLb+Ld)

is satisfied, the correction can be achieved without exceeding Ld.

A range for allowing burn-in is set to 1.5%. This range is based on the standards capable of recognizing colors as the same color, that is, the ASTM allowable color difference classification. Table 1 illustrates the standards.

TABLE 1
ASTM allowable color difference classification

| Color difference ΔE | Name | Remarks |
|---|---|---|
| 0.2 | Colorimetric impossible | |
| | region | |
| 0.3 | Recognition color difference | Colorimetric reproduction precision of the same |
| | | object |
| 0.6 | First class | Practical allowable difference limit in the case |
| | (strict color difference) | where various error factors are taken into account |
| 1.2 | Second class | When parallel determination is performed, most |
| | (practical color difference a) | people can easily recognize color difference |
| 2.5 | Third class | When separate determination is performed, colors |
| | (practical color difference b) | can be recognized as substantially the same color |
| | | Munsell AA class, JIS standard color chart |
| 5 | Fourth class | When time-dependent comparison is performed, |
| | | colors can be recognized as substantially the |
| | | same color |
| | | Munsell A class |
| 10 | Fifth class | Marking pen |
| 20 | Sixth class | Recognition display of piping system |

The Color Science Association of Japan, “Color Science Handbook (second edition)”, p. 290 (1998)

When colors are recognized as the same color, it is not determined that there is burn-in. Therefore, a color difference value is required to be maintained within ΔE=1.2 which is a color difference which most people can easily recognize in a case where the parallel determination is performed using the ASTM allowable color difference classification. The color difference is desirably maintained within ΔE=0.6.

When the chromaticity of the organic EL device is not changed depending on degradation and only the luminance thereof is degraded, the luminance degradations corresponding to the color differences ΔE=1.2 and 0.6 are 3.072% and 1.544%. Therefore, the degradation amount is desirably maintained within 3.072%, more desirably maintained within 1.544%. The color difference described here means a color difference in the CIELAB color space.

However, the present invention is not limited to such values and other values may be used.

The following display apparatuses can be proposed based on the descriptions.

(1) A display apparatus in which: a change in voltage of an organic EL device includes an irreversible voltage increase due to degradation and a reversible voltage increase without degradation; and a correction amount Lc is set in a range of

ΔVa/(ΔVo+ΔVa)≧Lc/ΔLb

where ΔVc represents a voltage change amount at a time of correction, Lc represents the correction amount (ratio of luminance to be corrected to luminance before degradation), ΔVo and ΔVa represent a reversible voltage increase when the organic EL device is degraded by Lc and an irreversible voltage increase amount due to degradation, respectively, and ΔLb represents a luminance degradation amount when ΔVa becomes equal to ΔVc.

(2) A display apparatus in which: a change in voltage of an organic EL device includes an irreversible voltage increase due to degradation and a reversible voltage increase without degradation; and a drive current supply time for one frame is set such that ΔVo is within a range of

ΔVa/(ΔVo+ΔVa)≧Lc/ΔLb

where ΔVc represents a voltage change amount at a time of correction, Lc represents a correction amount (ratio of luminance to be corrected to luminance before degradation), ΔVo and ΔVa represent a voltage increase amount without degradation of the organic EL device when the organic EL device is degraded by Lc and a voltage increase amount with luminance degradation, respectively, and ΔLb represents a luminance degradation amount when the voltage increase amount ΔVa with luminance degradation becomes equal to ΔVc.

(3) A display apparatus according to (1) or (2) in which Ld satisfies the following relationship

ΔVa/(ΔVo+ΔVa)≧Lc/(ΔLb+Ld)

when a degradation amount after correction is lower than 0 by Ld (ratio of luminance lower than 0 to luminance before degradation).

(4) A display apparatus according to (1) or (2) in which

0<ΔLb≦3.072%.

(5) A display apparatus according to (1) or (2) in which

0<ΔLb≦1.544%.

<Color Display Apparatus>

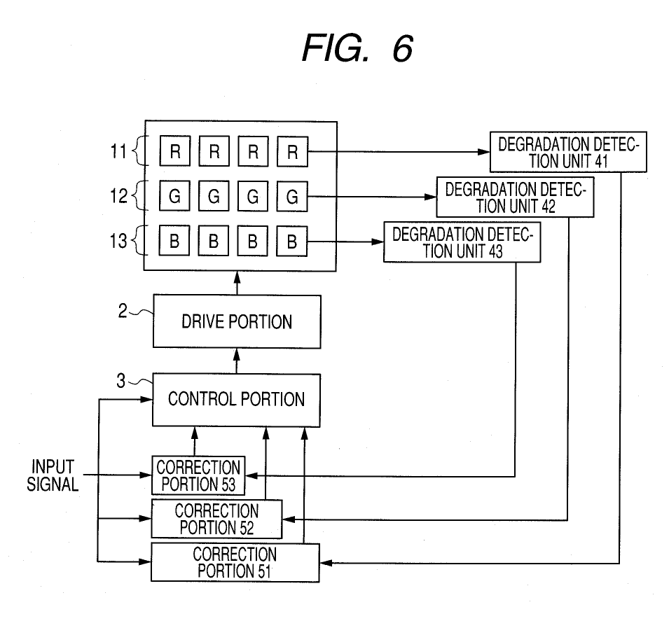

According to another embodiment of the present invention, in a display apparatus including a plurality of organic EL devices of different colors, the correction coefficient may be changed for each color. The display apparatus is illustrated in FIG. 6.

Each of the organic EL devices includes a multilayer film having an emission layer and a carrier injection layer. The organic EL devices of the different colors have different light-emitting materials and different layer thicknesses for respective colors.

In the display apparatus including the organic EL devices of the different colors such as R, G, and B, the correction amount determined based on the degradation amount and display luminance may be changed for each color. A degradation amount of organic EL devices 11 having a first color (R in this case) is detected by a first degradation detection unit 41. A correction coefficient is determined by a first correction portion 51 based on the degradation amount and display luminance. Similarly, a correction coefficient is determined by a second correction portion 52 based on a degradation amount of organic EL devices 12 each having a second color and display luminance thereof, and a correction coefficient is determined by a third correction portion 53 based on a degradation amount of organic EL devices 13 each having a third color and display luminance thereof. In this case, the correction can be performed according to the degradation characteristics of the organic EL devices, which are changed for the respective colors, and hence the change in luminance can be further reduced, which is desirable. In this embodiment, the degradation detection units are provided for respective different colors. The degradation amounts of the organic EL devices of all the colors may be detected by a single degradation detection unit.

A unit for determining the degradation amount is not necessarily a unit for detecting the degradation amount from a pixel to be corrected itself. The degradation amount of the pixel to be corrected may be estimated from a degradation amount of another pixel which is driven in the same manner as the pixel to be corrected.

A voltage may be detected every time of the writing or every several times of writing. When the voltage is detected every several times of writings, a portion for storing the degradation amounts of the respective organic EL devices is further provided. When the voltage is not detected, the correction amounts are determined based on the stored degradation amounts of the respective organic EL devices.

<Voltage Detection Method>

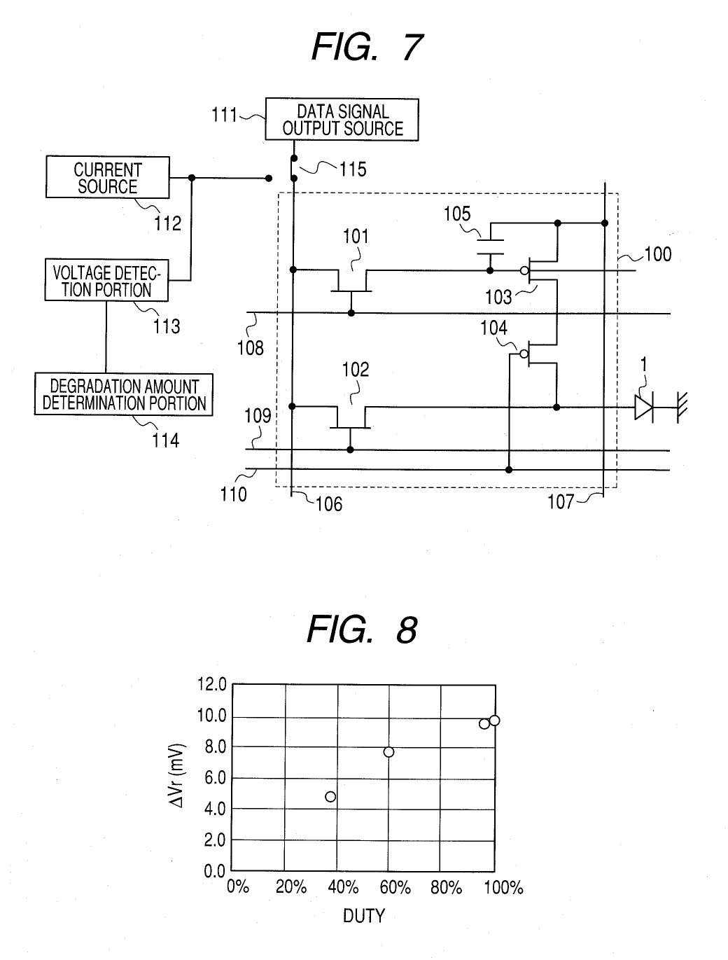

Next, a structure for reading a voltage applied to an organic EL device when a current of a predetermined value is supplied thereto is described with reference to FIG. 7.

FIG. 7 illustrates only one pixel in a matrix display apparatus including a plurality of pixels. A pixel 100 includes at least first and second N-type MOS transistors (NMOS) 101 and 102, first and second P-type MOS transistors (PMOS) 103 and 104, a storage capacitor 105, a data line 106, a power supply line 107, first, second, and third selection lines 108, 109, and 110, and the organic EL device 1. The data line 106 is switched between a data signal output source 111 and a group including a current source 112 and a voltage detection portion 113 in the outside of the pixel.

Hereinafter, an operation in this embodiment is described. Firstly, a light emitting operation is described. In a case of writing into the pixel, the first selection line is set to High and the second and third selection lines are set to Low. Then, the first NMOS is turned ON, the second NMOS is turned OFF, and the second PMOS is turned ON. Simultaneously, the data line is connected to the data signal output source to apply a data signal corresponding to display luminance. Then, the data signal is stored in the storage capacitor and the first PMOS causes a current corresponding to the data signal to flow from the power supply line to the organic EL device, whereby the organic EL device emits light with a desirable luminance. In a case of writing into another pixel, when the first, second, and third selection lines are set to Low, the organic EL device continues to emit light with the written luminance based on the voltage stored in the storage capacitor.

Next, a voltage detection operation is described. In this case, the first selection line is set to Low and the second and third selection lines are set to High. The data line is connected to the current source side to supply a predetermined current. Therefore, the potential of the data line is equal to a voltage applied to the organic EL device supplied with the predetermined current. When the potential is detected by the voltage detection portion, the voltage applied to the organic EL device supplied with the predetermined current can be detected.

The detected voltage is compared with an initial voltage of the pixel by a degradation amount determination portion 114 to detect the degradation amount. In other pixels other than the pixel for which degradation amount has been detected, the first and second selection lines are set to Low and the third selection line is set to High. Therefore, a current from the current source can be supplied to only a pixel for which degradation amount is to be detected.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-129579, filed May 16, 2008, which is hereby incorporated by reference herein in its entirety.

What is claimed is:

1. A display apparatus, comprising:
a light-emitting device provided for one pixel and having terminals;
a drive portion for supplying a drive current to the light-emitting device;
a voltage detection portion for detecting a voltage between the terminals of the light-emitting device;
a correction portion for correcting an input signal to acquire the drive current; and
a control portion for controlling the drive portion to supply the drive current to the light-emitting device,
wherein the correction portion corrects the input signal in a uniform way for every pixel in which an increase of the voltage detected by the voltage detection portion from a voltage at a start of driving exceeds a reference value.

2. The display apparatus according to claim 1, wherein the drive current after the correction is such a current to recover a degraded luminance to an original luminance.

3. The display apparatus according to claim 1, wherein the drive current after the correction is such a current to recover a degraded luminance to a luminance higher than an original luminance.

4. The display apparatus according to claim 1, wherein the way of the correction is to increase the drive current uniformly by a constant ratio for all pixels to which the correction is required.

5. The display apparatus according to claim 1, wherein the light-emitting device is provided in plurality so as to have different emission colors, and the display apparatus has the correction portion provided for each of the different emission colors.

6. The display apparatus according to claim 1, wherein, with respect to the corrected pixel, the voltage detection portion detects an increase from a voltage between the terminals of the light-emitting device immediately after correction, and the correction portion performs, for a pixel in which the increased voltage exceeds a second reference voltage, a correction to further increase the drive current.

7. The display apparatus according to claim 1, wherein the drive portion supplies the drive current to the light-emitting device at a duty ratio smaller than 1 during a frame period.
